(19) United States
(12) Patent Application Publication
(10) Pub. No.: US 2007/0025699 A1
(43) Pub. Date: Feb. 1, 2007

(54) Recording medium, method and apparatus for reproducing data, and method and apparatus for recording data

(75) Inventors: Kun Suk Kim, Anyang-si (KR); Jea Yong Yoo, Seongnam-si (KR)

Correspondence Address: HARNESS, DICKEY & PIERCE, P.L.C., P.O. BOX 8910, RESTON, VA, 20195, US

(73) Assignee: LG Electronics Inc.

(21) Appl. No.: 11/494,544

(22) Filed: Jul. 28, 2006

Related U.S. Application Data
(60) Provisional application No. 60/703,462, filed on Jul. 29, 2005.
(60) Provisional application No. 60/703,466, filed on Jul. 29, 2005.
(60) Provisional application No. 60/709,807, filed on Aug. 22, 2005.
(60) Provisional application No. 60/737,409, filed on Nov. 17, 2005.
(60) Provisional application No. 60/737,412, filed on Nov. 17, 2005.

(30) Foreign Application Priority Data
Mar. 16, 2006 (KR) 10-2006-0024491

(51) Int. Cl. H04N 7/00

(52) U.S. Cl. 386/95

(57) ABSTRACT

In one embodiment, a primary video stream and a secondary video stream are stored in a data area of the recording medium. The primary video stream represents a primary presentation path, and the secondary video stream represents a picture-in-picture presentation path with respect to the primary presentation path. Management information for managing reproduction of the picture-in-picture presentation path is stored in a management area of the recording medium. The management information includes composition information, and the composition information includes position information indicating a position to display the secondary video stream.

### FOREIGN PRIORITY INFORMATION

This application claims the benefit of the Korean Patent Application No. 10-2006-0024491, filed on Mar. 16, 2006, which is hereby incorporated by reference in its entirety.

### DOMESTIC PRIORITY INFORMATION

This application claims the benefit of the U.S. Provisional Application Nos. 60/703,462, 60/703,466, 60/709,807, 60/737,409 and 60/737,412 filed Jul. 29, 2005, Jul. 29, 2005, Aug. 22, 2005, Nov. 17, 2005 and Nov. 17, 2005, which are all hereby incorporated by reference in their entirety.

### BACKGROUND OF THE INVENTION

1. Field of the Invention

The present invention relates to recording and reproducing methods and apparatuses, and a recording medium.

2. Discussion of the Related Art

Optical discs are widely used as a recording medium capable of recording a large amount of data therein. Particularly, high-density optical recording mediums such as a Blu-ray Disc (BD) and a high definition digital versatile disc (HD-DVD) have recently been developed, and are capable of recording and storing large amounts of high-quality video data and high-quality audio data.

Such a high-density optical recording medium, which is based on next-generation recording medium techniques, is considered to be a next-generation optical recording solution capable of storing much more data than conventional DVDs. Development of high-density optical recording mediums is being conducted, together with other digital appliances. Also, an optical recording/reproducing apparatus, to which the standard for high density recording mediums is applied, is under development.

In accordance with the development of high-density recording mediums and optical recording/reproducing apparatuses, it is possible to simultaneously reproduce a plurality of videos. However, there is known no method capable of effectively simultaneously recording or reproducing a plurality of videos. Furthermore, it is difficult to develop a complete optical recording/reproducing apparatus based on high-density recording mediums because there is no completely-established standard for high-density recording mediums.

### SUMMARY OF THE INVENTION

The present invention relates to a recording medium having a data structure for managing reproduction of at least one picture-in-picture presentation path.

In one embodiment, a primary video stream and a secondary video stream are stored in a data area of the recording medium. The primary video stream represents a primary presentation path, and the secondary video stream represents a picture-in-picture presentation path with respect to the primary presentation path. Management information for managing reproduction of the picture-in-picture presentation path is stored in a management area of the recording medium. The management information includes composition information, and the composition information includes position information indicating a position to display the secondary video stream.

For example, the position information may include vertical position information including a vertical position to display a top left pixel of the secondary video stream on a display of the primary video stream. As another example, the position information may include horizontal position information including a horizontal position to display a top left pixel of the secondary video stream on a display of the primary video stream. As a still further example, the composition information may include scale information indicating a size to display the secondary video stream.

In another embodiment, the management information includes timing information, the timing information indicating a start of an interval in which the composition information is valid.

In a still further embodiment, the management information may include picture-in-picture timeline information. The picture-in-picture timeline information indicates whether the timing information refers to one of a timeline of a playitem and a timeline of a sub path. The playitem indicates a playing interval of the primary video stream and the sub path indicates a playing interval of the secondary video stream.

In one embodiment, a primary video stream and a secondary video stream are stored in a data area of the recording medium. The primary video stream represents a primary presentation path, and the secondary video stream represents a picture-in-picture presentation path with respect to the primary presentation path. Management information for managing reproduction of the picture-in-picture presentation path is stored in a management area of the recording medium. The management information includes composition information, and the composition information includes scale information indicating a size to display the secondary video stream.

The present invention further relates to methods and apparatuses for recording picture-in-picture video data on a recording medium, and methods and apparatuses for reproducing picture-in-picture video data from a recording medium.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principles of the invention. In the drawings:

FIG. 1 is a schematic view illustrating an example in which data of a recording medium and/or a storage is reproduced through an optical recording/reproducing apparatus;

FIG. 2 is a schematic diagram illustrating a structure of files recorded in an optical disc as a recording medium according to an embodiment of the present invention;

FIG. 3 is a schematic diagram illustrating a data recording structure of the optical disc as the recording medium according to an embodiment of the present invention;

FIG. 4 is a schematic diagram for understanding of the concept of a secondary video according to an embodiment of the present invention;

FIG. 5 is a block diagram illustrating the overall configuration of an optical recording/reproducing apparatus according to an embodiment of the present invention;

FIG. 6 is a block diagram schematically illustrating an exemplary embodiment of a playback system according to the present invention;

FIG. 7 is a schematic diagram illustrating an exemplary embodiment of a data reproducing apparatus using the playback system according to the present invention;

FIG. 8 is a schematic diagram illustrating an exemplary embodiment of status memory units equipped in the optical recording/reproducing apparatus according to the present invention;

FIG. 9 is a schematic diagram illustrating an exemplary embodiment of metadata according to the present invention;

FIGS. 10A to 10C are schematic diagrams for understanding of the concept of timeline types according to embodiments of the present invention;

FIG. 11 is a schematic view illustrating an exemplary embodiment of secondary video position information according to the present invention;

FIG. 12 is a schematic diagram illustrating an exemplary embodiment of a table containing entries of the secondary video streams according to the present invention; and

FIG. 13 is a flow chart illustrating an exemplary embodiment of a data reproducing method according to the present invention.

### DETAILED DESCRIPTION OF EXAMPLE EMBODIMENTS

Reference will now be made in detail to example embodiments of the present invention, which are illustrated in the accompanying drawings. Wherever possible, the same reference numbers will be used throughout the drawings to refer to the same or like parts.

In the following description, example embodiments of the present invention will be described in conjunction with an optical disc as an example recording medium. In particular, a Blu-ray disc (BD) is used as an example recording medium, for the convenience of description. However, it will be appreciated that the technical idea of the present invention is applicable to other recording mediums, for example, HD-DVD, equivalently to the BD.

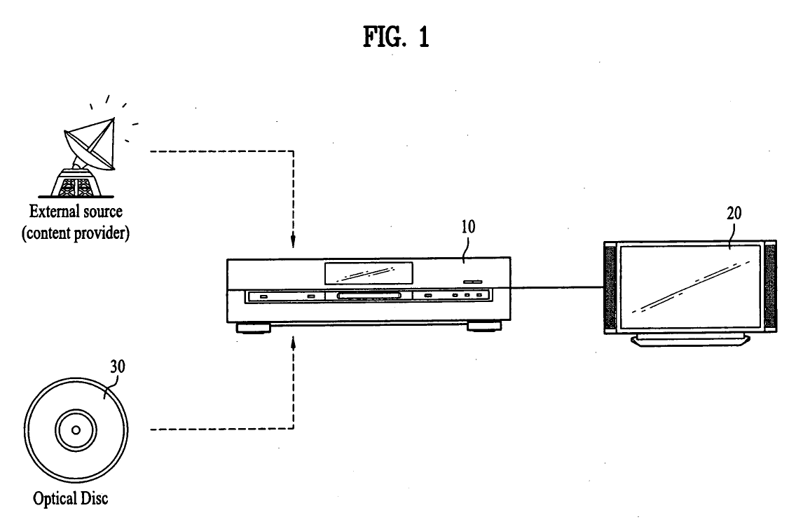

“Storage” as generally used in the embodiments is a storage equipped in a optical recording/reproducing apparatus (FIG. 1). The storage is an element in which the user freely stores required information and data, to subsequently use the information and data. For storages, which are generally used, there are a hard disk, a system memory, a flash memory, and the like. However, the present invention is not limited to such storages.

In association with the present invention, the “storage” is also usable as means for storing data associated with a recording medium (for example, a BD). Generally, the data stored in the storage in association with the recording medium is externally-downloaded data.

As for such data, it will be appreciated that partially-allowed data directly read out from the recording medium, or system data produced in association with recording and production of the recording medium (for example, metadata) can be stored in the storage.

For the convenience of description, in the following description, the data recorded in the recording medium will be referred to as “original data”, whereas the data stored in the storage in association with the recording medium will be referred to as “additional data”.

Also, “title” defined in the present invention means a reproduction unit interfaced with the user. Titles are linked with particular objects, respectively. Accordingly, streams recorded in a disc in association with a title are reproduced in accordance with a command or program in an object linked with the title. In particular, for the convenience of description, in the following description, among the titles including video data according to an MPEG compression scheme, titles supporting features such as seamless multi-angle and multi story, language credits, director's cuts, trilogy collections, etc. will be referred to as “High Definition Movie (HDMV) titles”. Also, among the titles including video data according to an MPEG compression scheme, titles providing a fully programmable application environment with network connectivity thereby enabling the content provider to create high interactivity will be referred to as “BD-J titles”.

FIG. 1 illustrates an exemplary embodiment of the combined use of an optical recording/reproducing apparatus according to the present invention and a peripheral appliance.

The optical recording/reproducing apparatus 10 according to an embodiment of the present invention can record or reproduce data in/from various optical discs having different formats. If necessary, the optical recording/reproducing apparatus 10 may be designed to have recording and reproducing functions only for optical discs of a particular format (for example, BD), or to have a reproducing function alone, except for a recording function. In the following description, however, the optical recording/reproducing apparatus 10 will be described in conjunction with, for example, a BD-player for playback of a BD, or a BD-recorder for recording and playback of a BD, taking into consideration the compatibility of BDs with peripheral appliances, which must be solved in the present invention. It will be appreciated that the optical recording/reproducing apparatus 10 of the present invention may be a drive which can be built in a computer or the like.

The optical recording/reproducing apparatus 10 of the present invention not only has a function for recording and playback of an optical disc 30, but also has a function for receiving an external input signal, processing the received signal, and sending the processed signal to the user in the form of a visible image through an external display 20. Although there is no particular limitation on external input signals, representative external input signals may be digital multimedia broadcasting-based signals, Internet-based signals, etc. Specifically, as to Internet-based signals, desired data on the Internet can be used after being downloaded through the optical recording/reproducing apparatus 10 because the Internet is a medium easily accessible by any person.

In the following description, persons who provide contents as external sources will be collectively referred to as a “content provider (CP)”.

“Content” as used in the present invention may be the content of a title, and in this case means data provided by the author of the associated recording medium.

Hereinafter, original data and additional data will be described in detail. For example, a multiplexed AV stream of a certain title may be recorded in an optical disc as original data of the optical disc. In this case, an audio stream (for example, Korean audio stream) different from the audio stream of the original data (for example, English) may be provided as additional data via the Internet. Some users may desire to download the audio stream (for example, Korean audio stream) corresponding to the additional data from the Internet, to reproduce the downloaded audio stream along with the AV stream corresponding to the original data, or to reproduce the additional data alone. To this end, it is desirable to provide a systematic method capable of determining the relation between the original data and the additional data, and performing management/reproduction of the original data and additional data, based on the results of the determination, at the request of the user.

As described above, for the convenience of description, signals recorded in a disc have been referred to as “original data”, and signals present outside the disc have been referred to as “additional data”. However, the definition of the original data and additional data is only to classify data usable in the present invention in accordance with data acquisition methods. Accordingly, the original data and additional data should not be limited to particular data. Data of any attribute may be used as additional data as long as the data is present outside an optical disc recorded with original data, and has a relation with the original data.

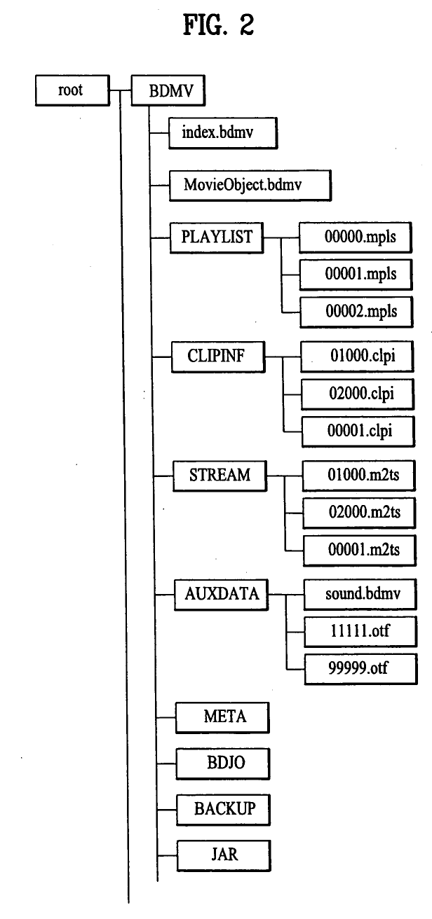

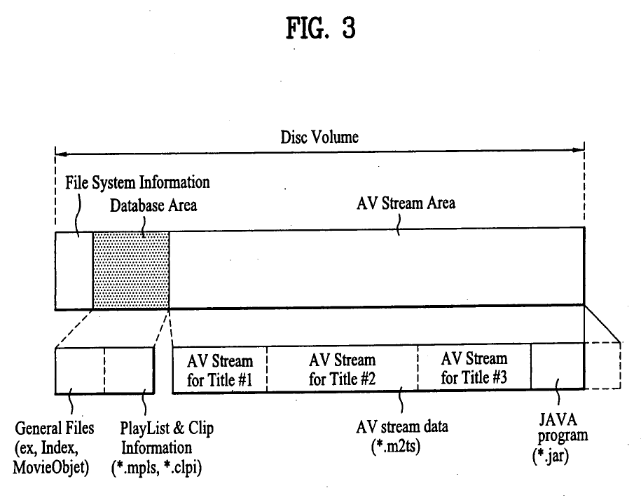

In order to accomplish the request of the user, the original data and additional data must have file structures having a relation therebetween, respectively. Hereinafter, file structures and data recording structures usable in a BD will be described with reference to FIGS. 2 and 3.

FIG. 2 illustrates a file structure for reproduction and management of original data recorded in a BD in accordance with an embodiment of the present invention.

The file structure of the present invention includes a root directory, and at least one BDMV directory BDMV present under the root directory. In the BDMV directory BDMV, there are an index file “index.bdmv” and an object file “MovieObject.bdmv” as general files (upper files) having information for securing an interactivity with the user. The file structure of the present invention also includes directories having information as to the data actually recorded in the disc, and information as to a method for reproducing the recorded data, namely, a playlist directory PLAYLIST, a clip information directory CLIPINF, a stream directory STREAM, an auxiliary directory AUXDATA, a BD-J directory BDJO, a metadata directory META, a backup directory BACKUP, and a JAR directory. Hereinafter, the above-described directories and files included in the directories will be described in detail.

The JAR directory includes JAVA program files.

The metadata directory META includes a file of data about data, namely, a metadata file. Such a metadata file may include a search file and a metadata file for a disc library. Such metadata files are used for efficient search and management of data during the recording and reproduction of data.

The BD-J directory BDJO includes a BD-J object file for reproduction of a BD-J title.

The auxiliary directory AUXDATA includes an additional data file for playback of the disc. For example, the auxiliary directory AUXDATA may include a “Sound.bdmv” file for providing sound data when an interactive graphics function is executed, and “11111.otf” and “99999.otf” files for providing font information during the playback of the disc.

The stream directory STREAM includes a plurality of files of AV streams recorded in the disc according to a particular format. Most generally, such streams are recorded in the form of MPEG-2-based transport packets. The stream directory STREAM uses “*.m2ts” as an extension name of stream files (for example, 01000.m2ts, 02000.m2ts, . . . ). Particularly, a multiplexed stream of video/audio/graphic information is referred to as an “AV stream”. A title is composed of at least one AV stream file.

The clip information (clip-info) directory CLIPINF includes clip-info files 01000.clpi, 02000.clpi, . . . respectively corresponding to the stream files “*.m2ts” included in the stream directory STREAM. Particularly, the clip-info files “*.clpi” are recorded with attribute information and timing information of the stream files “*.m2ts”. Each clip-info file “*.clpi” and the stream file “*.m2ts” corresponding to the clip-info file “*.clpi” are collectively referred to as a “clip”. That is, a clip is indicative of data including both one stream file “*.m2ts” and one clip-info file “*.clpi” corresponding to the stream file “*.m2ts”.

The playlist directory PLAYLIST includes a plurality of playlist files “*.mp1s”. “Playlist” means a combination of playing intervals of clips. Each playing interval is referred to as a “playitem”. Each playlist file “*.mp1s” includes at least one playitem, and may include at least one subplayitem. Each of the playitems and subplayitems includes information as to the reproduction start time IN-Time and reproduction end time OUT-Time of a particular clip to be reproduced. Accordingly, a playlist may be a combination of playitems.

As to the playlist files, a process for reproducing data using at least one playitem in a playlist file is defined as a “main path”, and a process for reproducing data using one subplayitem is defined as a “sub path”. The main path provides master presentation of the associated playlist, and the sub path provides auxiliary presentation associated with the master presentation. Each playlist file should include one main path. Each playlist file also includes at least one sub path, the number of which is determined depending on the presence or absence of subplayitems. Thus, each playlist file is a basic reproduction/management file unit in the overall reproduction/management file structure for reproduction of a desired clip or clips based on a combination of one or more playitems.

In association with the present invention, video data, which is reproduced through a main path, is referred to as a primary video, whereas video data, which is reproduced through a sub path, is referred to as a secondary video. The function of the optical recording/reproducing apparatus for simultaneously reproducing primary and secondary videos is also referred to as a “picture-in-picture (PiP)”.

In association with the present invention, the sub paths, which are used in a data reproduction operation, along with the main path, are mainly classified into three types. As to the sub path of the first type, elementary streams to be reproduced by the sub path (i.e., secondary video streams) are multiplexed in a state separate from a clip to be reproduced by a main path with the sub path. Namely, the secondary video streams are not multiplexed with the primary video stream representing the main path. This multiplexing is called “out-of-mux”. The reproduction path using the first type sub path is synchronous with the main path. On the other hand, the second type sub path is identical to the first type sub path in that secondary video streams to be reproduced by the sub path are multiplexed in a state separate from a clip to be reproduced by the main path. However, the second type sub path is different from the first type sub path in that, in the case of the second type sub path, the presentation of the sub path can begin at any time on the time line of the main path. That is, the sub path is asynchronous with the main path. Once the sub path presentation is started, the sub path presentation is then synchronized with the main path. As to the third type sub path, secondary video streams to be reproduced through the sub path are multiplexed in a clip which will be reproduced by a main path associated with the sub path. This multiplexing is called “in-mux”. The third type sub path is different from the second type sub path in that the reproduction path using the third type sub path is synchronous with the main path.

The backup directory BACKUP stores a copy of the files in the above-described file structure, in particular, copies of files recorded with information associated with playback of the disc, for example, a copy of the index file “index.bdmv”, object files “MovieObject.bdmv” and “BD-JObject.bdmv”, unit key files, all playlist files “*.mp1s” in the playlist directory PLAYLIST, and all clip-info files “*.clpi” in the clip-info directory CLIPINF. The backup directory BACKUP is adapted to separately store a copy of files for backup purposes, taking into consideration the fact that, when any of the above-described files is damaged or lost, fatal errors may be generated in association with playback of the disc.

Meanwhile, it will be appreciated that the file structure of the present invention is not limited to the above-described names and locations. That is, the above-described directories and files should not be understood through the names and locations thereof, but should be understood through the meaning thereof.

FIG. 3 illustrates a data recording structure of the optical disc according to an embodiment of the present invention. In FIG. 3, recorded structures of information associated with the file structures in the disc are illustrated. Referring to FIG. 3, it can be seen that the disc includes a file system information area recorded with system information for managing the overall file, an area recorded with the index file, object file, playlist files, clip-info files, and meta files (which are required for reproduction of recorded streams “*.m2ts”), a stream area recorded with streams each composed of audio/video/graphic data or STREAM files, and a JAR area recorded with JAVA program files. The areas are arranged in the above-descried order when viewing from the inner periphery of the disc.

In the disc, there is an area for recording file information for reproduction of contents in the stream area. This area is referred to as a “management area”. The file system information area and database area are included in the management area.

The areas of FIG. 3 are shown and described only for illustrative purposes. It will be appreciated that the present invention is not limited to the area arrangement of FIG. 3.

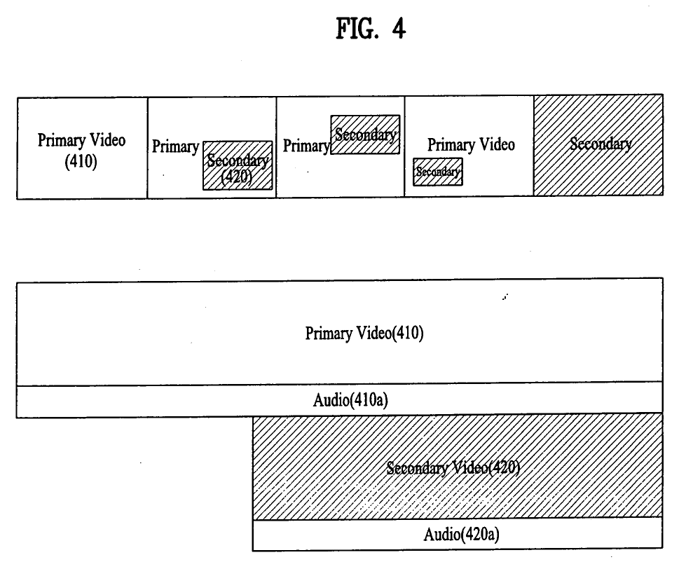

FIG. 4 is a schematic diagram for understanding of the concept of the secondary video according to embodiments of the present invention.

The present invention provides a method for reproducing secondary video data, simultaneously with primary video data. For example, the present invention provides an optical recording/reproducing apparatus that enables a PiP application, and, in particular, effectively performs the PiP application.

During reproduction of a primary video 410 as shown in FIG. 4, it may be necessary to output other video data associated with the primary video 410 through the same display 20 as that of the primary video 410. In accordance with the present invention, such a PiP application can be achieved. For example, during playback of a movie or documentary, it is possible to provide, to the user, the comments of the director or episode associated with the shooting procedure. In this case, the video of the comments or episode is a secondary video 420. The secondary video 420 can be reproduced simultaneously with the primary video 410, from the beginning of the reproduction of the primary video 410.

The reproduction of the secondary video 420 may be begun at an intermediate time of the reproduction of the primary video 410. It is also possible to display the secondary video 420 while varying the position or size of the secondary video 420 on the screen, depending on the reproduction procedure. A plurality of secondary videos 420 may also be implemented. In this case, the secondary videos 420 may be reproduced, separately from one another, during the reproduction of the primary video 410. The primary video 410 can be reproduced along with an audio 410a associated with the primary video 410. Similarly, the secondary video 420 can be reproduced along with an audio 420a associated with the secondary video 420.

For reproduction of the secondary video, information about the reproduction time, reproduction position, and reproduction size of the secondary video as well as information on the streams of the secondary video are provided. Also provided are information for defining audio streams, presentation graphics, or text sub-title streams (for example, PiP presentation graphics or text subtitle (PG TextST) streams) to be reproduced along with the secondary video and information for defining a possible reproduction combination of the above-described streams.

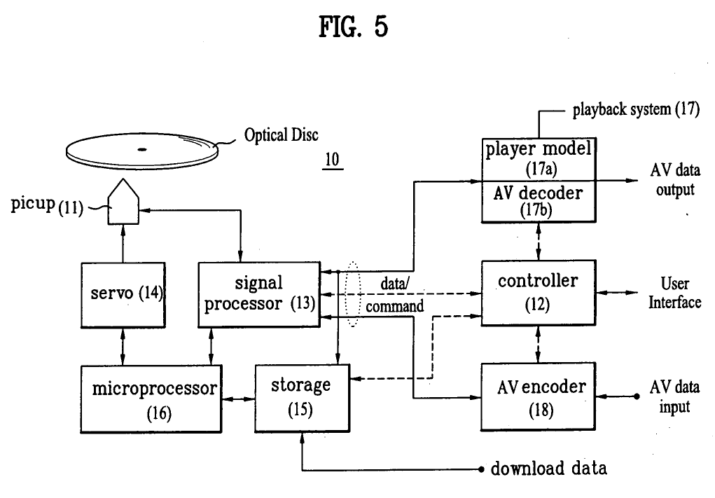

In addition, the optical recording/reproducing apparatus may be equipped with memory units (for example, player status registers (PSRs)) for storing information representing the reproduction status and reproduction environment of the secondary video. The present invention provides a method capable of satisfying the above-described requirements, and efficiently reproducing the secondary video along with the primary video. Hereinafter, the present invention will be described in detail with reference to FIG. 5 and the remaining drawings.

FIG. 5 illustrates an exemplary embodiment of the overall configuration of the optical recording/reproducing apparatus 10 according to the present invention.

As shown in FIG. 5, the optical recording/reproducing apparatus 10 mainly includes a pickup 11, a servo 14, a signal processor 13, and a microprocessor 16. The pickup 11 reproduces original data and management data recorded in an optical disc. The management data includes reproduction management file information. The servo 14 controls operation of the pickup 11. The signal processor 13 receives a reproduced signal from the pickup 11, and restores the received reproduced signal to a desired signal value. The signal processor 13 also modulates signals to be recorded, for example, primary and secondary videos, to signals recordable in the optical disc, respectively. The microprocessor 16 controls the operations of the pickup 11, the servo 14, and the signal processor 13. The pickup 11, the servo 14, the signal processor 13, and the microprocessor 16 are also collectively referred to as a “recording/reproducing unit”. In accordance with the present invention, the recording/reproducing unit reads data from an optical disc 30 or storage 15 under the control of a controller 12, and sends the read data to an AV decoder 17b. The recording/reproducing unit also receives an encoded signal from an AV encoder 18, and records the received signal in the optical disc 30. Thus, the recording/reproducing unit can record video and audio data in the optical disc 30.

The controller 12 downloads additional data present outside the optical disc 30 in accordance with a user command, and stores the additional data in the storage 15. The controller 12 also reproduces the additional data stored in the storage 15 and/or the original data in the optical disc 30 at the request of the user. In accordance with the present invention, the controller 12 generates metadata for managing reproduction of the secondary video, and controls the recording/reproducing unit to record the metadata in the optical disc 30, along with associated video data.

The optical recording/reproducing apparatus 10 further includes a playback system 17 for finally decoding data, and providing the decoded data to the user under the control of the controller 12. The playback system 17 includes an AV decoder 17b for decoding an AV signal. The playback system 17 also includes a player model 17a for analyzing an object command or application associated with playback of a particular title, for analyzing a user command input via the controller 12, and for determining a playback direction, based on the results of the analysis. In an embodiment, the player model 17a may be implemented as including the AV decoder 17a. In this case, the playback system 17 is the player model itself.

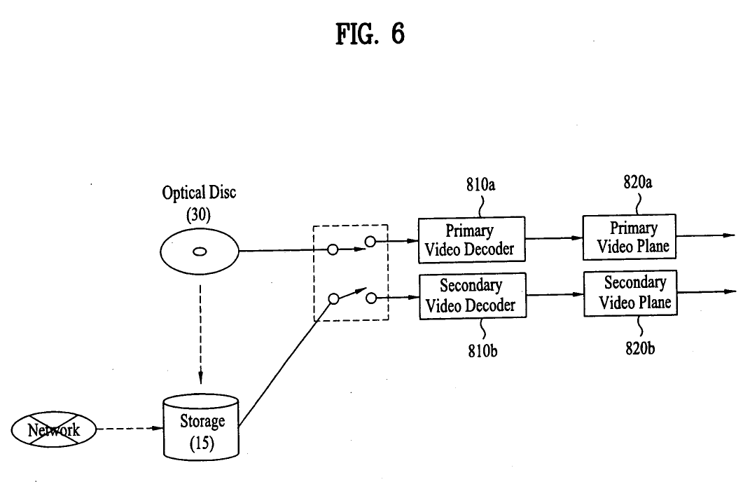

The AV decoder 17b may include a plurality of decoders. FIG. 6 schematically illustrates an exemplary embodiment of the playback system according to the present invention. Referring to FIG. 6, the AV decoder 17b includes a primary video decoder 810a for decoding the primary video, and a secondary video decoder 810b for decoding the secondary video. The decoded primary video is output through a primary video plane 820a, to be provided to the user, whereas the decoded secondary video is output through a secondary video plane 820b, to be provided to the user. In particular, the controller 12 checks the metadata for managing reproduction of the secondary video, and controls the secondary video decoder 810b in accordance with the metadata, to enable the secondary video to be displayed at a set time, at a set screen position, and in a set size. The time, position and/or size may be predetermined. The stream data of the primary video and/or secondary video may be stream data recorded in the recording medium, namely, the optical disc 30, or may be stream data stored in the storage 15 after being downloaded from the outside of the recording medium.

The AV encoder 18, which is also included in the optical recording/reproducing apparatus 10 shown in FIG. 5, converts an input signal to a signal of a particular format, for example, an MPEG2 transport stream, and sends the converted signal to the signal processor 13, to enable recording of the input signal in the optical disc 30.

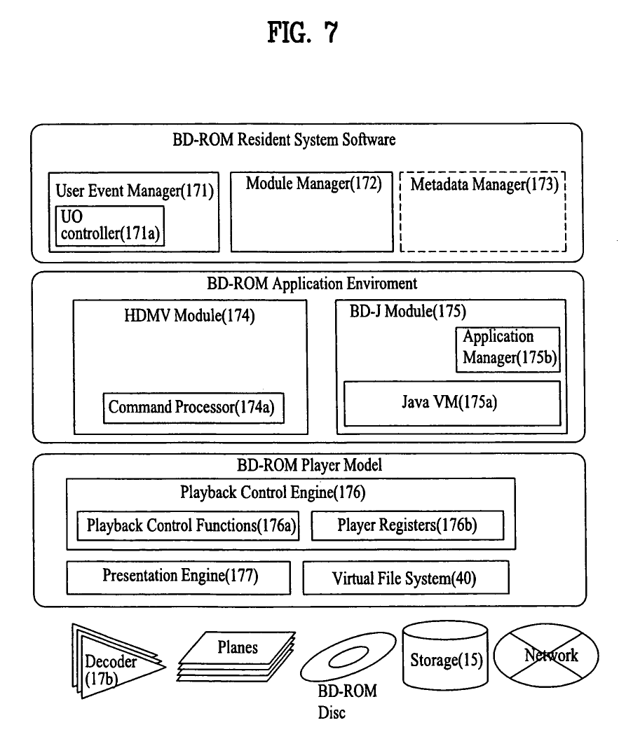

FIG. 7 is a schematic diagram explaining the playback system according to an embodiment of the present invention. In accordance with the present invention, the playback system can simultaneously reproduce the primary and secondary videos.

“Playback system” means a collective reproduction processing means which is configured by programs (software) and/or hardware provided in the optical recording/reproducing apparatus. That is, the playback system is a system which can not only play back a recording medium loaded in the optical recording/reproducing apparatus, but also can reproduce and manage data stored in the storage of the apparatus in association with the recording medium (for example, after being downloaded from the outside of the recording medium).

In particular, as shown in FIG. 6, the playback system 17 may include a user event manager 171, a module manager 172, a metadata manager 173, an HDMV module 174, a BD-J module 175, a playback control engine 176, a presentation engine 177, and a virtual file system 40. This configuration will be described in detail, hereinafter.

As a separate reproduction processing/managing means for reproduction of HDMV titles and BD-J titles, the HDMV module 174 for HDMV titles and the BD-J module 175 for BD-J titles are constructed independently of each other. Each of the HDMV module 174 and BD-J module 175 has a control function for receiving a command or program contained in the associated object “Movie Object” or “BD-J Object”, and processing the received command or program. Each of the HDMV module 174 and BD-J module 175 can separate an associated command or application from the hardware configuration of the playback system, to enable portability of the command or application. For reception and processing of the command, the HDMV module 174 includes a command processor 174a. For reception and processing of the application, the BD-J module 175 includes a Java Virtual Machine (VM) 175a, and an application manager 175b.

The Java VM 175a is a virtual machine in which an application is executed. The application manager 175b includes an application management function for managing the life cycle of an application processed in the BD-J module 175.

The module manager 172 functions not only to send user commands to the HDMV module 174 and BD-J module 175, respectively, but also to control operations of the HDMV module 174 and BD-J module 175. A playback control engine 176 analyzes the playlist file actually recorded in the disc in accordance with a playback command from the HDMV module 174 or BD-J module 175, and performs a playback function based on the results of the analysis. The presentation engine 177 decodes a particular stream managed in association with reproduction thereof by the playback control engine 176, and displays the decoded stream in a displayed picture. In particular, the playback control engine 176 includes playback control functions 176a for managing all playback operations, and player registers 176b for storing information as to the playback status and playback environment of the player (information of player status registers (PSRs) and general purpose registers (GPRs)). In some cases, the playback control functions 176a mean the playback control engine 176 itself.

The HDMV module 174 and BD-J module 175 receive user commands in independent manners, respectively. The user command processing methods of HDMV module 174 and BD-J module 175 are also independent of each other. In order to transfer a user command to an associated one of the HDMV module 174 and BD-J module 175, a separate transfer means should be used. In accordance with the present invention, this function is carried out by the user event manager 171. Accordingly, when the user event manager 171 receives a user command generated through a user operation (UO) controller 171a, the user event manager sends the received user command to the module manager 172 or UO controller 171a. On the other hand, when the user event manager 171 receives a user command generated through a key event, the user event manager sends the received user command to the Java VM 175a in the BD-J module 175.

The playback system 17 of the present invention may also include a metadata manager 173. The metadata manager 173 provides, to the user, a disc library and an enhanced search metadata application. The metadata manager 173 can perform selection of a title under the control of the user. The metadata manager 173 can also provide, to the user, recording medium and title metadata.

The module manager 172, HDMV module 174, BD-J module 175, and playback control engine 176 of the playback system according to the present invention can perform desired processing in a software manner. Practically, the processing using software is advantageous in terms of design, as compared to processing using a hardware configuration. Of course, it is general that the presentation engine 177, decoder 19, and planes are designed using hardware. In particular, the constituent elements (for example, constituent elements designated by reference numerals 172, 174, 175, and 176), each of which performs desired processing using software, may constitute a part of the controller 12. Therefore, it should be noted that the above-described constituents and configuration of the present invention be understood on the basis of their meanings, and are not limited to their implementation methods such as hardware or software implementation. Here, “plane” means a conceptual model for explaining overlaying procedures of the primary video, secondary video, PG (presentation graphics), IG (interactive graphics), text sub titles. In accordance with the present invention, the secondary video plane is arranged in front of the primary video plane. Accordingly, the secondary video output after being decoded is presented on the secondary video plane.

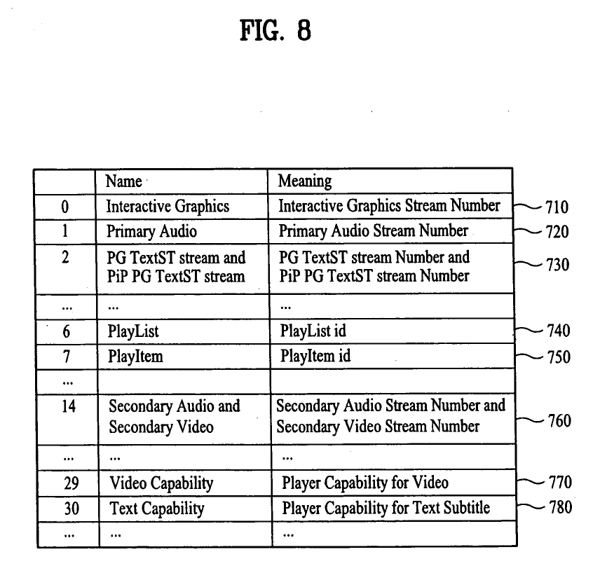

FIG. 8 illustrates an exemplary embodiment of the status memory units equipped in the optical recording/reproducing apparatus according to the present invention.

The player registers 176b included in the optical recording/reproducing apparatus 10 function as memory units in which information as to the recording/playback status and recording/playback environment of the player are stored. The player registers 176b may be classified into general purpose registers (GPRs) and player status registers (PSRs). Each PSR stores a playback status parameter (for example, an ‘interactive graphics stream number’ 710 or a ‘primary audio stream number’ 720), or a configuration parameter of the optical recording/reproducing apparatus (for example, a ‘player capability for video’ 770). Since a secondary video is reproduced, in addition to a primary video, in the present invention, it is also necessary to provide PSRs for the reproduction status of the secondary video.

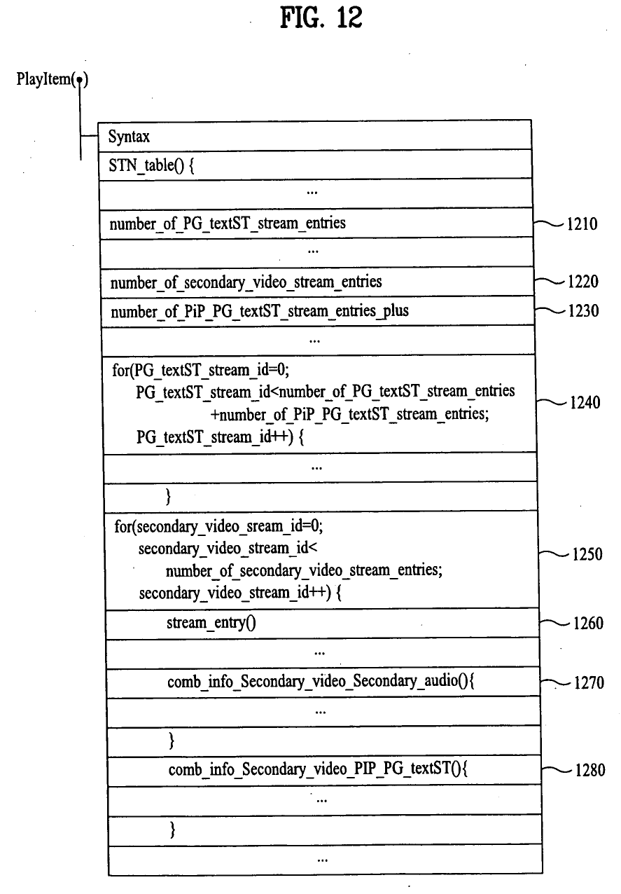

The stream number of the secondary video may be stored in one of the PSRs (for example, a PSR14 760). In the same PSR (namely, PSR14), the stream number of a secondary audio associated with the secondary video may also be stored. Referring to FIG. 8, the PSR14 760 is included in the optical recording/reproducing apparatus 10, to store the stream numbers of the secondary video and secondary audio, as described above. The ‘secondary video stream number’ stored in the PSR14 760 is used to specify which secondary video stream should be presented from secondary video stream entries in an STN table of the current playitem. Similarly, the ‘secondary audio stream number’ stored in the PSR14 760 is used to specify which secondary audio stream should be presented from secondary audio stream entries in the STN table of the current playitem. The STN table associated with the present invention will be described with reference to FIG. 12.

The PSR14 760 may store a flag representing whether presentation of the secondary video is enabled or disabled. For example, when the flag is set to an enabled state, the secondary video is decoded, and presented to the user through the secondary video plane 820b. On the other hand, if the flag is set to a disabled state, the user cannot view the secondary video even when the secondary video is decoded by the decoder 810b. The flag may be varied by the user operation, user command, or application programming interface (API).

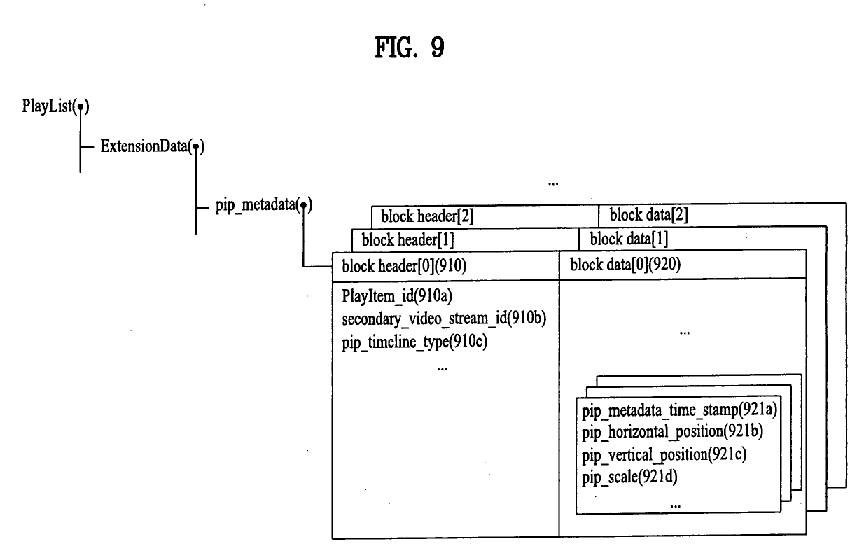

The PSR14 760 may also store the size of the secondary video. For example, when the PSR14 760 is stored with a secondary video size set to ‘0x0’, the presentation of the secondary video can be adjusted in size in accordance with secondary video scale information which will be described with reference to FIG. 9. On the other hand, when the PSR14 760 is stored with a secondary video size set to ‘0xF’, the presentation of the secondary video can be adjusted in size to a full screen size, irrespective of the scale information. In this regard, the secondary video can be adjusted to the same size as the primary video.

In accordance with the present invention, the secondary video can be reproduced along with presentation graphics or text subtitles (PG TextST). Therefore, a memory unit for storing information as to ‘PG TextST’ for the secondary video, for example, PSR2 730 is provided. Accordingly, when a secondary video stream is displayed during the presentation of the current playitem, the stream number of ‘PiP PG TextST’ in the PSR2 720 is used to specify which PG stream or Text ST stream should be presented from the ‘PG TextST’ streams in the STN table of the current playitem.

On the other hand, when no secondary video stream is displayed, namely, when the video presentation flag of the PSR14 760 is set to a disabled state, or when no secondary video stream is displayed during the presentation of the current playitem, the stream number of ‘PG TextST’ in the PSR2 720 is used to specify which PG stream or Text ST stream should be presented from the ‘PG TextST’ streams in the STN table of the current playitem.

The PSR2 720 may store a flag representing whether display of a PG TextST stream including a PiP PG TextST stream is enabled or disabled. When the flag stored in the PSR2 720 is set to a disable state, display of PG TextST stream is disabled. On the other hand, when the flag stored in the PSR2 720 is set to an enable state, a specified PG TextST stream can be displayed to the user. Similar to the secondary video presentation flag of the PSR14 760, the flag of the PSR2 720 is changeable between an enable state and a disable state by a user operation (UO), user command, or an application programming interface (API).

The PSR2 720 may also store a flag representing whether PiP PG TextST stream is valid. When a secondary video stream is displayed, the flag is used to represent which PG TextST stream number is used. For example, if the flag is set to ‘0_{b}’, the PG TextST stream number defined in the PSR2 720 is used when the current secondary video stream is displayed in the current playitem presentation. The ‘PG TextST’ is a PG TextST stream which is displayed in a program of the main video, namely, the primary video. On the other hand, if the flag is set to ‘1_{b}’, the PiP TextST stream number defined in the PSR2 720 is used. This flag has no effect for the optical recording/reproducing apparatus of the present invention when no secondary video stream is displayed. In such a case, the PG TextST stream defined in the PSR2 720 may be used. The value of the flag may be changeable by a navigation command, user operation (UO) or application programming interface.

The PSRs may include a memory unit for storing information representing the playitem which is currently presented, for example, a PSR7 750, and a memory unit for storing information representing a playlist for managing reproduction of a title which is currently presented, for example, a PSR6 740. Accordingly, the optical recording/reproducing apparatus of the present invention can identify the playlist, which is currently executed, and the playitem which is currently presented.

The PSRs may also include a memory unit for storing information representing a video capability of the optical recording/reproducing apparatus, for example, PSR29 770. For example, this memory unit (hereinafter, referred to as “PSR29 770”) can represent whether or not a secondary video of an HD quality can be reproduced, or whether or not a video of a particular frequency (for example, 50 or 25 Hz) can be reproduced. In one embodiment, it is impossible to change the values stored in the PSR29 770 by navigation commands or system applications (for example, a BD-J application).

In accordance with the present invention, the optical recording/reproducing apparatus has a function for processing text subtitle. The function for text subtitle may be optional. This function may include, for example, user changeable style set, user changeable palette, inline style, outline border, and text flow and alignment. Accordingly, to indicate whether or not the optical recording/reproducing apparatus of the present invention has a player capability, one of the PSRs included in the optical recording/reproducing apparatus is used; for example, a PSR30 780 may be used.

Where the above-described functions are partially or completely changed to mandatory functions which must be implemented, the player capability indication using a PSR may be dispensed with. That is, the player capability indication using a PSR is optional in the optical recording/reproducing apparatus.

FIG. 9 illustrates an exemplary embodiment of management data according to the present invention.

In order to reproduce the secondary video, it is necessary to use management data including information as to the reproduction attribute of the secondary video, for example, information about the reproduction time, reproduction size, and reproduction position of the secondary video, for example, metadata as to the secondary video. Hereinafter, the management data will be described in conjunction with an example in which the management data is PiP metadata.

The metadata may be included in a playlist which is a kind of a reproduction management file. FIG. 9 illustrates PiP metadata blocks included in an ‘ExtensionData’ block of a playlist managing reproduction of the primary video. The PiP metadata may include at least one block header ‘block_header[k]’ 910 and block data ‘block_data[k]’ 920. The number of the block header and block data is determined depending on the number of metadata block entries stored in PiP metadata. The block header 910 contains header information of the associated metadata block. The block data 920 contains the data information of the associated metadata block.

The block header 910 may include a field indicating playitem identifying information (hereinafter, referred to as ‘PlayItem_id[k]’) 910a, and a field representing secondary video stream identifying information (hereinafter, referred to as ‘secondary_video_stream_id[k]’) 910b. The ‘PlayItem_id[k]’ 910a has a value for a playitem of which STN table contains ‘secondary_video_stream_id’ entry that is referred to by the ‘secondary_video_stream_id[k]’ 910b. The ‘PlayItem_id’ value is given in the playlist block of the playlist file. Preferably, in the PiP metadata, the entries of ‘PlayItem_id’ value in the pip metadata are sorted in an ascending order of the ‘PlayItem_id’ value. The ‘secondary_video_stream_id[k]’ 910b is used to identify a sub path, and a secondary video stream to which the associated block data 920 is applied. This field indicates a secondary_video_stream_id value in the STN table of the playitem referred to by the ‘playitem_id[k]’ 910a.

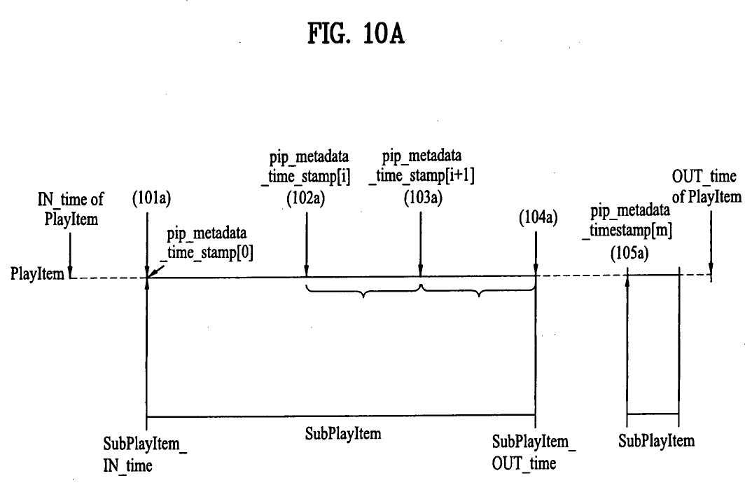

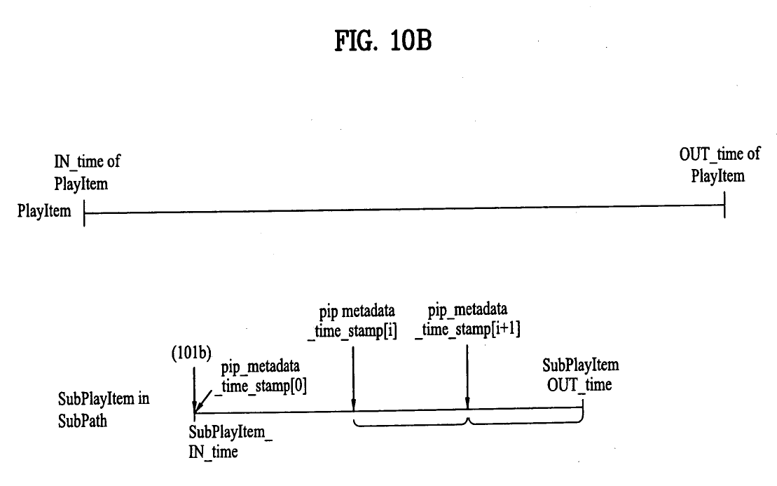

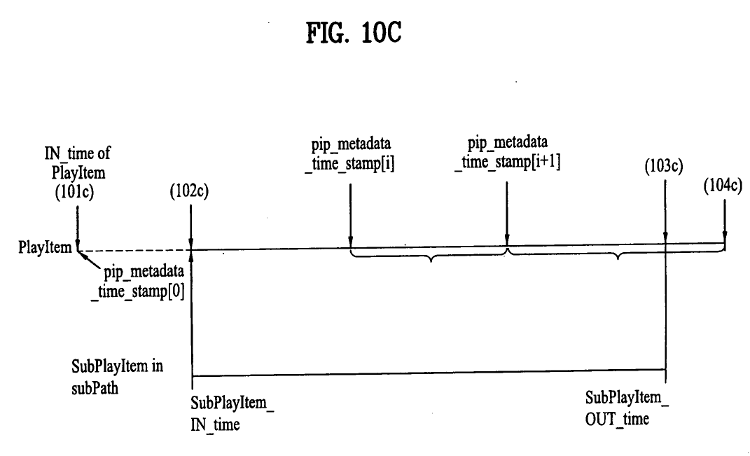

The block header 910 may also include information indicating types of a timeline to which the associated PiP metadata refer (hereinafter, referred to as ‘pip_timeline_type’ 910c). FIGS. 10A to 10C are schematic diagrams for conceptual understanding of time line types according to the present invention. Meanwhile, the block data 920 may include a time stamp that indicates a point where PiP metadata is placed (hereinafter, ‘pip_metadata_time_stamp’) 921a. The ‘pip_timeline_type[k]’ 910c can be identified in accordance with the type of the timeline to the associated ‘pip_metadata_time_stamp[i]’ entries refer.

FIG. 10A illustrates the case in which the PiP presentation path is synchronous with the main path, and the entries of ‘pip_metadata_time_stamp’ refer to the timeline of the playitem indicated by the PiP metadata. In FIG. 10A, the ‘pip_metadata_time_stamp’ points to a presentation time from the interval that the associated subplayitem intervals are projected on the timeline of the playitem referred to by the ‘PlayItem_id[k]’ 910a. In the timeline type of FIG. 10A, it is preferred that ‘pip_metadata_time_stamp[0]’ and ‘pip_metadata_time_stamp[m]’ are put at the beginning 101a and 105a of each of the intervals that the associated subplayitem intervals are projected on the timeline of the playitem referred to by the ‘playitem_id[k]’ 910a, respectively.

As described above, PiP metadata includes block data 920. The block data 920 includes at least one secondary video composition information (hereinafter, referred to as ‘pip_composition_metadata’), the number of which is determined depending on the number of ‘pip_metadata_time_stamp’. The i-th ‘pip_composition_metadata’ is valid in the interval from ‘pip_metadata_time_stamp[i]’ 102a inclusive to ‘pip_metadata_time_stamp[i+1]’ 103a. The last ‘pip_composition_metadata’ of the last ‘pip_metadata_time_stamp’ in the block data 920 is valid in the interval from the last ‘pip_metadata_time_stamp’ inclusive to the presentation end time 104a of the sub path indicated by ‘secondary_video_stream_id’ included in the PiP metadata.

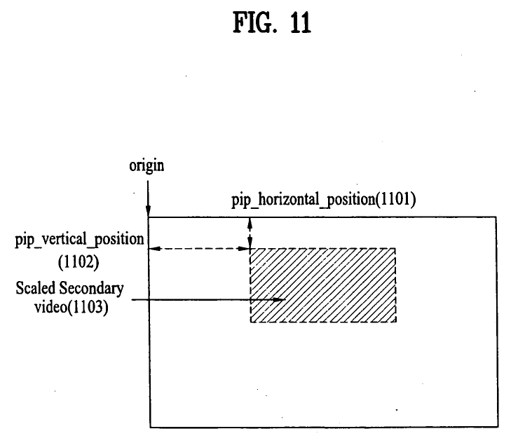

The secondary video composition information is information representing the reproduction position and size of the secondary video. Referring to FIG. 9, the secondary video composition information may include position information of the secondary video, and size information of the secondary video (hereinafter, referred to as ‘pip_scale’ 921d). The position information of the secondary video includes horizontal position information of the secondary video (hereinafter, referred to as ‘pip_horizontal position’ 921b), and vertical position information of the secondary video (hereinafter, referred to as ‘pip_vertical_position’ 921c). Referring to FIG. 11, an exemplary embodiment of the position information of the secondary video according to the present invention will be described. In FIG. 11, ‘pip_horizontal_position’ 921b represents a horizontal position 1101 of the secondary video displayed on a screen when viewing from an origin of the screen, and ‘pip_vertical_position’ 921c represents a vertical position 1102 of the secondary video displayed on the screen when viewing from the origin of the screen. The display position of the secondary video on the screen is determined by the position information 921b and 921c.

The size of the secondary video is determined by ‘pip_scale’ 921d. As described above in conjunction with FIG. 8, the size of the secondary video can be adjusted up to the size of the primary video. The size of the secondary video may be set to a discrete value, for efficient reproduction of the secondary video. The size of the secondary video may be represented by a scale to the size of the primary video, for example, ‘x1’, ‘x1/2’, ‘x1/4’, or ‘x1/5’.

In the embodiment of FIG. 10A, the sub path indicated by the above-described ‘secondary_video_stream_id’ 910b is usually the first type or second type described in conjunction with FIG. 2 because the PiP presentation path is synchronous with the main path.

In the timeline type of FIG. 10A, the secondary video refers to the timeline of the main path because the secondary video is reproduced synchronously with the main path. That is, when the main path jumps or moves back to a certain position, the secondary video is reproduced according to the position and scale information of the ‘pip_metadata_time_stamp’ associated with the time to which reproduction of the main path has jumped or moved back. Accordingly, the secondary video streams are reproduced along the timeline of the main path.

FIG. 10B illustrates the case in which the PiP presentation path is asynchronous with the main path, and the timeline of the sub path is referred to by the entries of ‘pip_metadata_time_stamp’. In the embodiment of FIG. 10B, the sub path indicated by the above-described ‘secondary_video time_stamp id’ 910b is usually the second type described in conjunction with FIG. 2 because the PiP presentation path is asynchronous with the main path. In the timeline type of FIG. 10B, ‘pip_metadata_time_stamp’ points to a presentation time in the subplayitem interval contained in the sub path indicated by ‘secondary_video_stream_id[k]’ included in the PiP metadata. In this timeline type, it is preferred that ‘pip_metadata_time_stamp[0]’ be put at the beginning point 101b of the subplayitem interval contained in the sub path indicated by ‘secondary_video_stream_id[k]’.

In the timeline type of FIG. 10B, the secondary video is reproduced through the sub path, irrespective of the reproduction procedure through the main path, because the secondary video refers to the timeline of the subplayitem. That is, the timeline type of FIG. 10B is different from the timeline type of FIG. 10A in that, even when the reproduction point of the main path is changed to a certain point on the timeline of the playitem of the main path, the presentation position and scale of the secondary video is not changed.

FIG. 10C illustrates the case in which the PiP presentation path is asynchronous with the main path, and the timeline of the playitem indicated by ‘PlayItem_id[k]’ in the PiP metadata is referred to by the entries of ‘pip_metadata_time_stamp’. Similarly to the timeline type of FIG. 10A, the timeline of the playitem is referred to in the timeline type of FIG. 10C. Accordingly, the reproduction start time of the subplayitem, namely, ‘SubPlayItem_IN_time’, is projected on the timeline of the playitem at a point 102c. In the time line type of FIG. 10C, ‘pip_metadata_time_stamp’ indicates a presentation time of the interval of the playitem indicated by ‘PlayItem_id[k]’. In the time line type of FIG. 10C, it is preferred that ‘pip_metadata_time_stamp[0]’ be put at the beginning 101c of the playitem interval referred to by ‘PlayItem_id[k]’. The timeline type of FIG. 11C is similar to the timeline type of FIG. 11A. In the case of the timeline type of FIG. 11C, ‘pip_metadata_time_stamp[0]’ is placed at the beginning point 101c of the interval of the playitem. However, in the case of the timeline type of FIG. 11A, ‘pip_metadata_time_stamp[0]’ is put at the beginning point 101a of the interval that the associated subplayitem interval is projected on the timeline of the playitem referred to by the ‘playitem_id[k]’.

The last ‘pip_composition_metadata’ in one block data 920 is valid until the presentation end time of the sub path indicated by ‘secondary_video stream_id’ in the PiP metadata. Thus, ‘pip_metadata_time_stamp[i+1]’ is valid until the out time 104c of the current playitem. After the sub playitem out time 103c, however, the secondary video is no longer displayed because the secondary video is reproduced through the sub path.

In the embodiment of FIG. 10C, the sub path indicated by the above-described ‘secondary_video_time_stamp_id’ 910b is preferable of the second type described in conjunction with FIG. 2 because the PiP presentation path is asynchronous with the main path.

In the timeline type of FIG. 10C, when the presentation position of the main path jumps or moves back to a certain position, the metadata at that position is applied to the secondary video which has begun to be reproduced Referring to FIG. 10C, it can be seen that, for example, when the presentation position of the main path moves back from the position of ‘pip_metadata_time_stamp[i+1]’ to the position of ‘pip_metadata_time_stamp[i]’ under the condition in which ‘pip_composition_metadata[i+1]’ corresponding to ‘pip_metadata_time_stamp[i+1]’ has been applied to the secondary video, ‘pip_composition metadata[i]’ corresponding to ‘pip_metadata_time_stamp[i]’ is applied to the secondary video, and thus, is reproduced.

The description of the valid time information, position information, and size information of the secondary video given in conjunction with the embodiment of FIG. 10A are equivalently applied to the cases of FIGS. 10B and 10C.

Although the reproduction time information and composition information of PiP metadata has been described as being included in the playlist, in the embodiment of FIG. 9, they may be included in the headers of secondary video streams implementing PiP.

FIG. 12 illustrates an exemplary embodiment of a table containing information about the secondary video streams according to the present invention. The table (hereinafter, referred to as an “STN table”) defines a list of elementary streams selectable by the optical recording/reproducing apparatus during the presentation of the current playitem and sub paths associated with the current playitem. For the STN table of each playitem, it depends on the content provider to decide which elementary stream of the main clip and sub paths have an entry in this STN table.

The optical recording/reproducing apparatus of the present invention has functions for processing the secondary video, secondary audio, presentation graphics, and text subtitles. Accordingly, the STN table of the present invention stores the entries associated with the secondary video, secondary audio, presentation graphics, and text subtitles.

Referring to FIG. 12, the STN table of the present invention includes a value indicating the secondary video stream number corresponding to the value of ‘secondary_video_stream_id’. As defined in block 1250 of FIG. 12, the value of ‘secondary_video_stream_id’ is initially set to ‘0’, and is incremented by ‘1’ unless the value of ‘secondary_video_stream_id’ is equal to the number of secondary video streams; namely, the value of ‘number_of_secondary video_stream_entries’ 1220. Accordingly, the secondary video stream number is equal to a value obtained by adding ‘1’ to the value of ‘secondary_video_stream_id’.

A stream entry block 1260 is defined in the STN table in accordance with the above-described ‘secondary_video_stream_id’. The stream entry block includes the type of database for identifying an elementary stream referred to by the stream number for the stream entry block. In accordance with the present invention, the stream entry block includes information for identifying the sub path associated with the reproduction of the secondary video, and information for identifying the subclip entry defined in the subplayitem of the sub path referred to by the sub path identifying information.

In the optical recording/reproducing apparatus of the present invention, it is possible to identify the stream entry block associated with the reproduction of the secondary video, based on ‘PlayItem_id’ 910a and ‘secondary_video_stream_id’ 910b included in the PiP metadata described in conjunction with FIG. 9. Since the stream entry block includes information for identifying the associated sub path and sub path clip entry, it is possible to reproduce appropriate streams for the reproduction of the secondary video. Once ‘PlayItem_id’ 910a and ‘secondary_video_stream_id’ 910b are determined, the reproduction time of the secondary video and the reproduction order of the secondary video streams are determined because the secondary video is presented through the sub path. The ‘pip_metadata_time_stamp’ 921a refers to the timeline of the associated playitem or subplayitem indicated by ‘pip_timeline_type’ 910c. The secondary video is presented at a predetermined position and in a predetermined size in accordance with the ‘pip_composition_metadata’ corresponding to the ‘pip_metadata_time_stamp’ 921a.

The ‘PlayItem_id’ 910a, ‘secondary_video_stream_id’ 920b, ‘pip_timeline type’ 910c, and ‘pip_metadata_time_stamp’ 921a may be considered in a broad sense to correspond to the time information of PiP metadata because they are associated with the reproduction time of the secondary video. However, in a viewpoint of the timeline referred to PiP metadata, only the information ‘pip_timeline_type’ 910c and ‘pip_metadata_time_stamp’ 921a may be considered to be time information.

In accordance with the present invention, the STN table also includes a value indicating the ‘PiP PG textST’ stream number for the presentation graphics/text subtitle stream entry associated with the value of ‘PiP_PG_textST_stream_id’. The value of ‘PiP_PG_textST_stream_id’ is equal to the value of ‘PG_textST_stream_id’. The ‘PiP PG textST’ stream number is equal to a value obtained by adding ‘1’ to the value of ‘PG_textST_stream_id’. As defined in block 1210 of FIG. 12, the value of ‘PiP_PG_textST_stream_id’ is initially set to ‘0’, and is incremented by ‘1’ unless the value of ‘PiP_PG_textST_stream_id’ is equal to a value obtained by adding the number of additional ‘PG textST’ stream entries for PiP application (i.e., ‘number_of_PiP_PG_textST_stream_entries_plus’ 1230) to the number of ‘PG textST’ stream entries (i.e., ‘number_of_PG_textST_stream_entries’ 1210).

During the reproduction of the secondary video along with the primary video in accordance with the present invention, namely, during execution of a PiP application, secondary audio or ‘PiP PG textST’ streams may be reproduced. In this case, the reproduction relation between the secondary video and the secondary audio or ‘PG textST’ to be reproduced along with the secondary video should be defined. To this end, in accordance with the present invention, allowed combinations of the secondary video and secondary audio and allowed combinations of the secondary video and ‘PiP PG textST’ streams are included in the STN table.

Referring to FIG. 12, the STN table of the playitem includes a ‘comb_Secondary_video_Secondary_audio’ block 1270 in accordance with the present invention. The ‘comb_Secondary_video_Secondary_audio’ block 1270 defines allowed combinations of the corresponding secondary video stream and ‘PiP PG textST’streams. That is, the block 1270 includes information as to secondary audio streams allowed to be presented with the secondary video stream. The secondary audio stream information may include, for example, the number of secondary audio streams allowed to be presented with the secondary video stream, and information for identifying the secondary audio streams (for example, ‘secondary_audio_stream_id’).

The STN table also includes a ‘comb_info_Secondary_video_Pip_PG_textST’ block 1280 in accordance with the present invention. The ‘comb_info_Secondary_video_PiP_PG_textST’ block 1280 includes information as to ‘PiP PG textST’ streams allowed to be presented with the secondary video stream. The ‘PiP PG textST’ stream information may include, for example, the number of ‘PiP PG textST’ streams allowed to be presented with the secondary video stream, and information for identifying the ‘PiP PG textST’ streams (for example, ‘PiP_PG_textST_stream_id’).

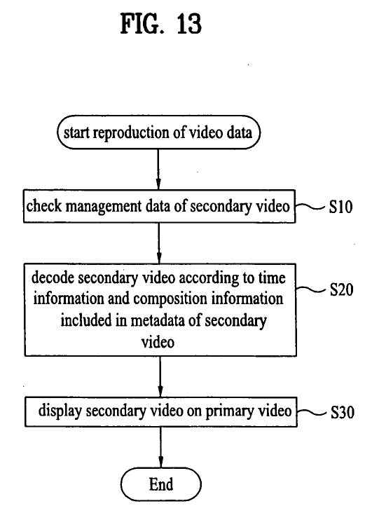

FIG. 13 illustrates an exemplary embodiment of a data reproducing method according to the present invention.

In accordance with the data reproducing method, when reproduction of video data is begun, the optical recording/reproducing apparatus 10 of the present invention checks metadata for managing reproduction of the secondary video (S10). The metadata includes information associated with the reproduction of the secondary video. The metadata may be included in the playlist file, as in the embodiment of FIG. 9. The controller 12 controls the secondary video decoder 810b to decode secondary video stream in accordance with the metadata (S20). The metadata includes information as to the reproduction time of the secondary video and the composition information of the secondary video. The composition information may include ‘pip_horizontal_position’ 921b, ‘pip_vertical_position’ 921c, and ‘pip_scale’ 921d. The time information may include ‘PlayItem_id’ 910a, ‘secondary_video_stream_id’ 920b, ‘pip_timeline_type’ 910c, and ‘pip_metadata_time_stamp’ 921a, as described in conjunction with FIG. 12. Accordingly, the secondary video decoder 810b decodes the secondary video at the time defined by the time information, to cause the secondary video to be displayed at a position defined by the composition information, and in a size defined by the composition information. Thus, the decoded secondary video is displayed on a screen 20 on which the primary video is being displayed, to be viewed by the user (S30).

The primary video and secondary video may be supplied from the recording medium 30 or storage 15 to the associated decoders, respectively. That is, all primary and secondary videos to be reproduced may be supplied from the recording medium 30. It is also possible to supply all primary and secondary videos, to be reproduced, from the storage 15. Alternatively, it is possible to supply the primary video from the recording medium 30, and to supply the secondary video from the storage 15, unless the primary and secondary videos are multiplexed in the same stream. Of course, the case opposite to the above-described case may be possible. However, where both the primary and secondary videos are stored in the recording medium 30, one of the primary and secondary videos may be copied to the storage 15, in order to enable the primary and secondary videos to be simultaneously reproduced.

As apparent from the above description, in accordance with the recording medium, data reproducing method and apparatus, and data recording method and apparatus of the present invention, it is possible to reproduce the secondary video simultaneously with the primary video. In addition, the reproduction can be efficiently carried out. Accordingly, there are advantages in that the content provider can compose more diverse contents, to enable the user to experience more diverse contents.

It will be apparent to those skilled in the art that various modifications and variations can be made in the present invention without departing from the spirit or scope of the inventions. Thus, it is intended that the present invention covers the modifications and variations of this invention.

What is claimed is:

1. A recording medium having a data structure for managing reproduction of at least one picture-in-picture presentation path, comprising:
a data area storing a primary video stream and a secondary video stream, the primary video stream representing a primary presentation path, the secondary video stream representing a picture-in-picture presentation path with respect to the primary presentation path; and
a management area storing management information for managing reproduction of the picture-in-picture presentation path, the management information including composition information, the composition information including position information indicating a position to display the secondary video stream.

2. The recording medium of claim 1, wherein the position information includes vertical position information and horizontal position information, the vertical position information including a vertical position to display a top left pixel of the secondary video stream on a display of the primary video stream, and the horizontal position information including a horizontal position to display a top left pixel of the secondary video stream on a display of the primary video stream.

3. The recording medium of claim 2, wherein the composition information includes scale information indicating a size to display the secondary video stream.

4. A recording medium having a data structure for managing reproduction of at least one picture-in-picture presentation path, comprising:
a data area storing a primary video stream and a secondary video stream, the primary video stream representing a primary presentation path, the secondary video stream representing a picture-in-picture presentation path with respect to the primary presentation path; and
a management area storing management information for managing reproduction of the picture-in-picture presentation path, the management information including composition information, the composition information including scale information indicating a size to display the secondary video stream.

5. The recording medium of claim 4, wherein the scale information indicates a scale of the display of the secondary video stream with respect to the primary video stream.

6. The recording medium of claim 5, wherein the scale information indicates one of no scale, one-half scale, one-quarter scale, one and one-half scale, and full scale.

7. A method of managing reproduction of at least one picture-in-picture presentation path, comprising:
reproducing management information for managing reproduction of at least a picture-in-picture presentation path, the management information including composition information, the composition information including position information indicating a position to display a secondary video stream, the secondary video stream representing the picture-in-picture presentation path with respect to a primary presentation path represented by a primary video stream; and
reproducing the primary video stream and the secondary video stream based on the management information.

8. The method of claim 7, wherein the position information includes vertical position information including a vertical position to display a top left pixel of the secondary video stream on a display of the primary video stream.

9. The method of claim 7, wherein the position information includes horizontal position information including a horizontal position to display a top left pixel of the secondary video stream on a display of the primary video stream.

10. The method of claim 9, wherein the position information includes vertical position information including a vertical position to display a top left pixel of the secondary video stream on a display of the primary video stream.

11. The method of claim 10, wherein the composition information includes scale information including a size to display the secondary video stream.

12. The method of claim 11, wherein the scale information indicates a scale of the display of the secondary video stream with respect to the primary video stream.

13. The method of claim 12, wherein the scale information indicates one of no scale, one-half scale, one-quarter scale, one and one-half scale, and full scale.

14. The method of claim 10, wherein the management information includes timing information, the timing information indicating a start of an interval in which the composition information is valid.

15. The method of claim 14, wherein the management information include picture-in-picture timeline information, the picture-in-picture timeline information indicates whether the timing information refers to one of a timeline of a playitem and a timeline of a sub path, the playitem indicating a playing interval of the primary video stream, and the sub path indicating a playing interval of the secondary video stream.

16. The method of claim 15, the picture-in-picture timeline information further indicates whether the secondary video stream is to be displayed synchronously with the primary video stream.

17. The method of claim 7, wherein the management information includes timing information, the timing information indicating a start of an interval in which the composition information is valid.

18. The method of claim 17, wherein the management information include picture-in-picture timeline information, the picture-in-picture timeline information indicates whether the timing information refers to one of a timeline of a playitem and a timeline of a sub path, the playitem indicating a playing interval of the primary video stream, and the sub path indicating a playing interval of the secondary video stream.

19. The method of claim 18, wherein the picture-in-picture timeline information further indicates whether the secondary video stream is to be displayed synchronously with the primary video stream.

20. The method of claim 7, wherein the composition information includes scale information indicating a size to display the secondary video stream.

21. The method of claim 20, wherein the scale information indicates a scale of the display of the secondary video stream with respect to the primary video stream.

22. The method of claim 21, wherein the scale information indicates one of no scale, one-half scale, one-quarter scale, one and one-half scale, and full scale.

23. The method of claim 20, wherein the reproducing the primary video stream and the secondary video stream step reproduces the primary and secondary video streams such that the secondary video stream is displayed at a position indicated by the position information and at a size indicated by the scale information.

24. The method of claim 7, wherein the reproducing the primary video stream and the secondary video stream step reproduces the primary and secondary video streams such that the secondary video stream is displayed at a position indicated by the position information.

25. The method of claim 7, wherein the reproducing the primary video stream and the secondary video stream step decodes the secondary video stream using a different decoder than a decoder used to decode the primary video stream.

26. A method of managing reproduction of at least one picture-in-picture presentation path, comprising:
reproducing management information for managing reproduction of at least a picture-in-picture presentation path, the management information including composition information, the composition information including scale information indicating a size to display the secondary video stream, the secondary video stream representing the picture-in-picture presentation path with respect to a primary presentation path represented by a primary video stream; and
reproducing the primary video stream and the secondary video stream based on the management information.

27. The method of claim 26, wherein the scale information indicates a scale of the display of the secondary video stream with respect to the primary video stream.

28. The method of claim 26, wherein the scale information indicates one of no scale, one-half scale, one-quarter scale, one and one-half scale, and full scale.

29. An apparatus for managing reproduction of at least one picture-in-picture presentation path, comprising:
a driver configured to drive a reproducing device to reproduce data from the recording medium; and
a controller configured to control the driver to reproduce management information for managing reproduction of at least a picture-in-picture presentation path, the management information including composition information, the composition information including position information indicating a position to display a secondary video stream, the secondary video stream representing the picture-in-picture presentation path with respect to a primary presentation path represented by a primary video stream; and
the controller configured to control the driver to reproduce the primary video stream and the secondary video stream based on the management information.

30. The apparatus of claim 29, wherein the position information includes vertical position information and horizontal position information, the vertical position information including a vertical position to display a top left pixel of the secondary video stream on a display of the primary video stream, and the horizontal position information including a horizontal position to display a top left pixel of the secondary video stream on a display of the primary video stream.

31. The apparatus of claim 30, wherein the composition information includes scale information indicating a size to display the secondary video stream.

32. The apparatus of claim 29, further comprising:
a first decoder configured to decode the primary video stream; and
a second decoder configured to decode the secondary video stream.

33. An apparatus for managing reproduction of at least one picture-in-picture presentation path, comprising:
a driver configured to drive a reproducing device to reproduce data from the recording medium; and
a controller configured to control the driver to reproduce management information for managing reproduction of at least a picture-in-picture presentation path, the management information including composition information, the composition information including scale information indicating a size to display a secondary video stream, the secondary video stream representing the picture-in-picture presentation path with respect to a primary presentation path represented by a primary video stream; and
the controller configured to control the driver to reproduce the primary video stream and the secondary video stream based on the management information.

34. The apparatus of claim 33, wherein the scale information indicates a scale of the display of the secondary video stream with respect to the primary video stream.

35. The apparatus of claim 34, wherein the scale information indicates one of no scale, one-half scale, one-quarter scale, one and one-half scale, and full scale.

36. A method of recording a data structure for managing reproduction of at least one picture-in-picture presentation path, comprising:
recording a primary video stream and a secondary video stream in a data area of the recording medium, the primary video stream representing a primary presentation path, the secondary video stream representing a picture-in-picture presentation path with respect to the primary presentation path; and
recording management information for managing reproduction of the picture-in-picture presentation path in a management area of the recording medium, the management information including composition information, the composition information including position information indicating a position to display the secondary video stream.

37. The method of claim 36, wherein the position information includes vertical position information and horizontal position information, the vertical position information including a vertical position to display a top left pixel of the secondary video stream on a display of the primary video stream, and the horizontal position information including a horizontal position to display a top left pixel of the secondary video stream on a display of the primary video stream.

38. The method of claim 37, wherein the composition information includes scale information indicating a size to display the secondary video stream.

39. The method of claim 36, wherein the recording a primary video stream and a secondary video stream step records the primary and secondary video streams such that the primary and secondary video stream can be separated from a data stream reproduced from the recording medium and decoded by separate decoders.

40. An apparatus for recording a data structure for managing reproduction of at least one picture-in-picture presentation path, comprising:
a driver configured to drive a recording device to record data on the recording medium;
a controller configured to control the driver to record a primary video stream and a secondary video stream in a data area of the recording medium, the primary video stream representing a primary presentation path, the secondary video stream representing a picture-in-picture presentation path with respect to the primary presentation path; and
the controller configured to control the driver to record management information for managing reproduction of the picture-in-picture presentation path in a management area of the recording medium, the management information including composition information, the composition information including position information indicating a position to display the secondary video stream.

41. The apparatus of claim 40, wherein the position information includes vertical position information and horizontal position information, the vertical position information including a vertical position to display a top left pixel of the secondary video stream on a display of the primary video stream, and the horizontal position information including a horizontal position to display a top left pixel of the secondary video stream on a display of the primary video stream.

42. The apparatus of claim 41, wherein the composition information includes scale information indicating a size to display the secondary video stream.

43. The apparatus of claim 40, wherein the controller is configured to control the driver to record the primary video stream and the secondary video stream such that the primary and secondary video stream can be separated from a data stream reproduced from the recording medium and decoded by separate decoders.

44. The apparatus of claim 29, further comprising:
at least one filter configured to separate at least one of the primary video stream and the secondary video stream from data reproduced from the recording medium.
